(19) United States
(12) Patent Application Publication
(10) Pub. No.: US 2025/0108540 A1
(43) Pub. Date: Apr. 3, 2025

(54) LOW SOLIDS TALALAY COMPOSITIONS AND METHODS FOR THE SAME

(71) Applicant: Talalay Global, Inc., Shelton, CT (US)

(72) Inventors: Luc Tack, Deinze (BE); Michael Quinn, Middletown, CT (US); Remy Tack, Wielsbeke (BE); Patrick Jovan Boutviseth, New Haven, CT (US)

(21) Appl. No.: 18/897,476

(22) Filed: Sep. 26, 2024

Related U.S. Application Data
(60) Provisional application No. 63/541,066, filed on Sep. 28, 2023.

(51) Int. Cl. B29C 44/04; B29K 9/06; B29K 105/04

(52) U.S. Cl. CPC B29C 44/0407; B29K 2009/06; B29K 2105/04; B29K 2995/0063

(57) ABSTRACT

Molded latex foam blocks having dual densities and methods for the same are disclosed herein. The method may include preparing a latex composition including one or more rubber materials, disposing the latex composition into a mold, foaming the latex composition inside the mold, and curing the latex composition to produce a solid block of foam having dual densities. The solid block of foam may be a monolithic structure have a first side having a first density and a second side having a second density, where the first density is relatively greater than the second density.

### CROSS-REFERENCE TO RELATED APPLICATIONS

This application claims priority to U.S. Provisional Patent Application No. 63/541,066 filed on Sep. 28, 2023, the contents of which are incorporated herein by reference to the extent consistent with the present disclosure.

### TECHNICAL FIELD

This following description generally relates to latex foam products, and more specifically to latex foam products prepared with a low solids latex formulation and latex foam products made with a solid block of foam having a dual density.

### BACKGROUND

Latex foam is used in a wide variety of applications, including bedding products, footwear, cosmetics, seating, and specialty products, like sports equipment, etc. For example, latex foam is conventionally used in bedding products, such as mattresses, pillows, and mattress toppers. Latex foam is particularly desirable because it is durable and provides a high level of comfort and support. Conventional latex foam manufacturing processes use a high rubber solid content, typically from about 60% to about 70% or more of rubber solids. The higher rubber solids content is typically achieved by dehydrating latex rubber prior to foaming. Recently, the latex industry has been moving towards utilizing higher solids latex formulations for a variety of reasons, including ease and cost efficiency of shipping to the manufacturing facility. This is because the dehydrated high solids latex has relatively less water content. Additionally, high solids latex is easier to process, requires less machine cleaning, reduces the amount of shrinkage, and produces less waste. The dehydration process for high solids latex formulations, however, is complex, time-consuming, and energy intensive. As such, conventional dehydration processes for high solids latex formulations require significant manufacturing costs that may be cost prohibitive.

No two consumers are alike in size, shape, personal fitness level, health, preferred sleeping position, or comfort preference. These are among the many factors that affect the ability of a conventional mattress or pillow assembly to compensate for the individualized firmness of each consumer. Additionally, the requirements of each consumer may change significantly over the lifespan of the bedding product as consumer's weight, activity level, health, and preferred sleeping position may change. Conventional bedding manufacturers have attempted to compensate for the infinite combination of consumer preferences by releasing several models of firmness for each bedding line. In particular, manufacturers strive to have consumers fit into a soft/plush/firm/ultra-firm class of bedding. Additionally, mattress toppers and pillow toppers are often used to provide additional comfort and to offer more customized firmness levels to a consumer. Such toppers are disposed at the top surface of the mattress or pillow, and may consist of foam relatively thinner than the mattress and coextensive with the length and width of the mattress or pillow. The thickness of the topper can be selected based on the amount of support and cushioning desired by the consumer. The toppers, however, are separately purchased by the consumers and result in added cost. Additionally, the toppers may shift while in use, thereby negatively impacting consumer comfort and experience.

Bedding manufacturers have also utilized composite foam layers in a bedding product in an attempt to increase comfort and provide more customer customization. Layers or sections of latex foam having varying densities are first molded separately and then attached or coupled together to create a bedding product having different firmness characteristics. Conventional methods for coupling layers or sections of latex foam with one another often includes a mechanical process, such as stitching, gluing, or bonding. These methods for coupling latex foam layers often require additional manufacturing steps and materials, thereby resulting in additional costs. Additionally, gluing or bonding the layers of latex foam with one another also reduces the lifetime of the bedding product as the glue or bonding agent often exhibits reduced adhesion over the lifetime of the bedding product. Further, maintaining consistency during the mechanical processes for coupling layers of latex foam with one another is difficult.

Accordingly, there remains a need for latex foam products that utilize latex foam formulation having a lower solids content to reduce the cost of manufacturing and shipping, and reduce manufacturing process time. There is also a need for a monolithic molded latex foam product that has a plurality of densities (e.g., dual density) within the same molded block, without the need to adhere latex foam pieces of varying density together to create a more customized customer experience.

### BRIEF SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

The foregoing and/or other aspects and utilities described herein may be achieved by providing a method of manufacturing a latex foam product. The method may include: preparing a latex composition comprising one or more rubber materials; disposing the latex composition into a mold; foaming the latex composition inside the mold; and curing the latex composition to produce a solid block of foam; wherein the solid block of foam may have a top side with a first density and a bottom side with a second density, wherein the first density may be different from the second density.

In one aspect, the one or more rubber materials may include one or more natural rubbers, one or more synthetic rubbers, or a mixture thereof.

In one aspect, the one or more rubber materials may include styrene-butadiene rubber (SBR).

In one aspect, the latex foam product may be a mattress, a pillow, or a mattress topper.

In one aspect, preparing the latex composition may include diluting the latex composition with water to decrease a viscosity thereof.

In one aspect, the one or more rubber materials may include a rubber solids content of about 55% or less.

In one aspect, the one or more rubber materials may include a rubber solids content of about 40% to about 45%.

In one aspect, the first density may be relatively greater than the second density.

In one aspect, the method may further include: creating a vacuum in the mold; flash freezing the latex composition; directing carbon dioxide into the mold; and curing the latex composition inside the mold with heat.

The foregoing and/or other aspects and utilities described herein may be achieved by providing a molded latex foam block. The molded latex form block may include one or more rubber materials. The molded latex foam block may be prepared in a single mold operation. The molded latex foam block may have a top side and a bottom side. The top side may have a first density and the bottom side may have a second density. The first density may be about 10% to about 90% of the second density.

In one aspect, the one or more rubber materials may include about 70% to about 80% styrene-butadiene rubber (SBR) and about 20% to about 30% natural latex.

In one aspect, the one or more rubber materials may include a rubber solids content of about 55% or less.

In one aspect, the one or more rubber materials may include a rubber solids content of about 41% to about 45%.

In one aspect, the molded latex foam block may further include at least one additive. The at least one additive may include one or more of a dye, a gelling agent, an accelerator, a curing agent, a soap, or any combination thereof.

In one aspect, the molded latex foam block may be free or substantially free from one or more thickeners and/or viscosity increasing agents.

In one aspect, the top side may have a density of about 2 kg/m³ to about 4 kg/m³ and the bottom side may have a density of about 3 kg/m³ to about 5 kg/m³.

In one aspect, the molded latex foam block may be a monolithic foam block.

In one aspect, the molded latex foam block may include or have an Impression Load Deflection value of about 1 to about 80, or about 2 to about 50.

The foregoing and/or other aspects and utilities described herein may be achieved by providing a method of manufacturing a latex foam product. The method may include: preparing a latex composition including one or more rubber materials having a rubber solids content of about 55% or less; disposing the latex composition into a mold; foaming the latex composition inside the mold; and curing the latex composition to produce a solid block of foam.

In one aspect, the latex composition may have a viscosity of about 800 centipoise or more.

In one aspect, the solid block of foam may have a substantially consistent density.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the subject matter and, together with the description, serve to explain the principles thereof.

FIG. 1 illustrates an exemplary process for manufacturing a latex foam product, according to one or more embodiments disclosed herein.

FIG. 2 illustrates a perspective view of a bedding product, according to one or more embodiments disclosed herein.

FIG. 3 illustrates a cross-sectional view of the bedding product of FIG. 2 along line X-X, according to one or more embodiments disclosed herein.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, 3% (inclusive) of that numeral, 5% (inclusive) of that numeral, 10% (inclusive) of that numeral, or ±15% (inclusive) of that numeral. It should further be appreciated that when a numerical range is discussed herein, any numerical value falling within the range is also specifically included.

As used herein, “free” or “substantially free” of a material may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition with a cited reference, the present teachings control.

Molded latex compositions having relatively lower rubber solids content and methods for producing molded latex foam from the same are disclosed. The present inventors have surprisingly and unexpectedly discovered that molded latex compositions having relatively lower rubber solids content than that utilized in conventional latex compositions and manufacturing methods thereof may be prepared and utilized for fabricating latex foam blocks having dual densities. The present inventors have also surprisingly and unexpectedly discovered that using pre-agglomeration latex materials without the agglomeration step may produce a more open cell structure latex foam having increased airflow. The present inventors have also surprisingly and unexpectedly discovered that latex compositions having a low rubber solids content and a viscosity of about 300 centipoise to about 500 centipoise may be utilized to prepare solid blocks of latex foam having dual densities or firmness. The present inventors have further surprisingly and unexpectedly discovered that relatively lower amounts or excluding one or more thickening agents may lower the viscosity of the latex formulation to thereby facilitate the formation of dual density solid blocks of latex foam.

The latex foam composition may utilize natural latex rubber, synthetic latex rubber, and/or combinations thereof. In some embodiments, the formulation may use a mixture of synthetic latex rubber and natural latex rubber. Synthetic rubber may be styrene-butadiene rubber (“SBR”) or any other suitable synthetic rubber. Natural latex may be rubber from the Hevea tree or any other suitable type of natural latex rubber.

The ratio of synthetic latex to natural latex may be from about 1:99 (i.e., about 1 to about 99) to about 99:1 (i.e., about 99 to about 1), or from about 10:90 to about 90:10, or from about 80:20 to about 20:80, or from about 70:30 to about 30:70, or from about 60:40 to about 40:60, or about 50:50. In some advantageous embodiments, the ratio of synthetic latex to natural latex may be from about 60:40 to about 80:20. In some particularly preferred embodiments, the ratio of synthetic latex to natural latex may be about 80:20. It should be appreciated that that the latex foam formulation may also utilize 100% natural latex or 100% synthetic latex.

Latex material may include, consist essentially of, or consists of emulsions of one or more polymers in water with one or more added agents, such as emulsifiers, stabilizers, or the like, or any combination thereof. Latex material may be obtained by emulsion polymerization (e.g., agglomeration). The agglomeration process may increase the particle size of the polymers in these emulsions. The principle of latex agglomeration techniques may be the transition from a stable state, in which latex may contain fine particles of polymer (pre-agglomeration state), to another stable state, in which latex contains large particles of polymer (post-agglomeration state), under the effect of physical (freezing agglomeration, pressure agglomeration, etc.), chemical or physico-chemical means. The final stable state may be further facilitated by a post-stabilization of latex, if necessary. The method of the present disclosure may be utilized with pre-agglomeration latex material, post-agglomeration latex material, or a combination thereof. As such, the process may avoid the need to carry out the agglomeration step when preparing latex base component (prior to foaming), which would lead to significant improvements in terms of complexity, time, and cost of the manufacturing process. The inventors have discovered that using pre-agglomeration latex material without the agglomeration step creates a more open cell structure latex foam, which creates more airflow, among other things, and may have advantages for certain applications.

In some embodiments, the composition may use a lower rubber solids content in the synthetic latex base component. In other embodiments, a lower solids content in the natural latex base component may be used. Further, the composition may have a lower rubber solids content in both the synthetic latex and natural latex base components.

The rubber solids content of the one or more latex base components of the composition may preferably be about 55% or less. In some embodiments, the rubber solids content is in a range of about 30% to about 50%, preferably in a range of about 32% to about 45%, more preferably around 41%, and/or more preferably around 32% solids.

A lower rubber solids content may be achieved by diluting a higher solids latex compound (e.g., 70% or more rubber solids) with water or another suitable diluent until a desired solids content is reached. In some embodiments, viscosity of the latex base component with the low rubber solids content is preferably between about 300 centipoise (cP) to about 500 centipoise. The viscosity may be determined at a temperature of about 25° C. The present inventors have found unexpectedly that the latex composition with a low rubber solids content and viscosity of about 300 centipoise to about 500 centipoise produces a solid block of latex foam having dual densities or firmness, as discussed in more detail below. Accordingly, dual density solid blocks of latex foam are disclosed herein.

Furthermore, a quantity of fillers, thickeners, and viscosity modifying agents in the latex composition may be modified to achieve lower or higher viscosity composition. In some embodiments that utilize a rubber solids content of about 55% or less, one or more fillers, thickeners, and viscosity modifying agents may be added to the liquid latex composition prior to the foaming/molding process to increase the viscosity of the composition. In certain embodiments, the viscosity of the liquid latex composition may be around 800 centipoise to 1,200 centipoise, or around 1,000 centipoise, or more. Such compositions were found by the inventors to produce a solid block of foam having substantially consistent density throughout the block.

The latex composition may include various additional ingredients. In some embodiments, the composition includes at least one additive selected from dyes, compounding agents, thickeners, fillers, stabilizers, foaming agents, gelling agents, accelerators, curing agents, soaps, or the like, or any combination or mixture thereof. Any suitable variants of the listed additives may also be utilized.

Foaming agents may be capable of or configured to turn the liquid latex composition into foam. Suitable foaming agents may be or include, but are not limited to, one or more surfactants, blowing agents, or a combination thereof. Surfactants may reduce surface tension of the liquid latex composition, which makes it easier for the foam to form, or increase colloidal stability of the liquid composition by inhibiting coalescence of bubbles. The blowing agents may be a gas that forms the gaseous part of the foam. In some embodiments, carbon dioxide gas may be used as the blowing agent.

Thickening or gelling agents may be used to increase the viscosity of a liquid latex base component and to convert the liquid foam into gel. Typical thickening or gelling agents used for latex formulations may be used in the formulation disclosed herein. Illustrative agents may be or include, but are not limited to, sulfur-containing compounds, chlorides, acetates, fluorides, zinc salts, or the like, or any combination thereof. Higher amounts of thickening agents make the latex composition more viscous and typically result in a more consistent firmness of the resulting block of latex foam. On the other hand, lower amounts or absence of thickening agents in the formulation lower the viscosity of the latex formulation, which the inventors have unexpectedly found facilitates formation of a dual density solid block of latex foam. In some preferred embodiments, the latex formulation does not include any thickeners.

Typical ingredients that may be used as fillers in the composition of the present disclosure may be or include, but are not limited to, aluminum trioxide, aluminum silicate, calcium carbonate, magnesium hydroxide, fiberglass Portland cement, barites, fly ash, ground glass (i.e., glass cullet), rubber crumb, other inorganic materials, or the like, or any combination thereof.

Stabilizers may function to stabilize the foam structure generated by mechanical aeration. Various stabilizers known in the art may be utilized, including but not limited to oleate and ricinoleate soaps, fatty alcohol sulphates, fatty alcohol ether sulphates, alkyl aryl sulphonates, sulphosuccinates, sulphosuccinamates, or the like, or any combination thereof.

The latex foam formulation may be particularly useful with the Talalay manufacturing process. The Talalay process is a method of producing molded pieces of latex foam rubber. The Talalay method may include introducing a liquid latex rubber base into a closed mold, and vacuuming the air out of the closed mold. The mold may then be frozen to stabilize the cell structure and maintain uniform bubble geometry. Carbon dioxide gas may then be flooded through the frozen, open foam matrix to form carbonic acid (CO₂+H₂O→H₂CO₃). The carbonic acid may lower the pH, thereby causing gelation. In the next process step, the mold may be heated to cure/vulcanize the mixture, which locks the foam into a uniform bubble distribution.

A compound of relative high ammonia content may be employed, and one of the functions of the carbon dioxide may be to increase the solubility of the zinc oxide through the formation of ammonium ions and the fall in pH. Gelation occurs by interaction between complex zinc ions and fatty acid-like stabilizers. Compounded latex may be converted, without prior maturation, into fairly heavy density foam. A carefully metered amount of this pre-foam may be transferred into the mold, and a partial vacuum may be applied after mold closure. Expansion of the foam may take place, after which the foam may be frozen and gelled with carbon dioxide. The frozen and gelled foam may be thawed and vulcanized by means of fluids which may be circulated through the body of the mold.

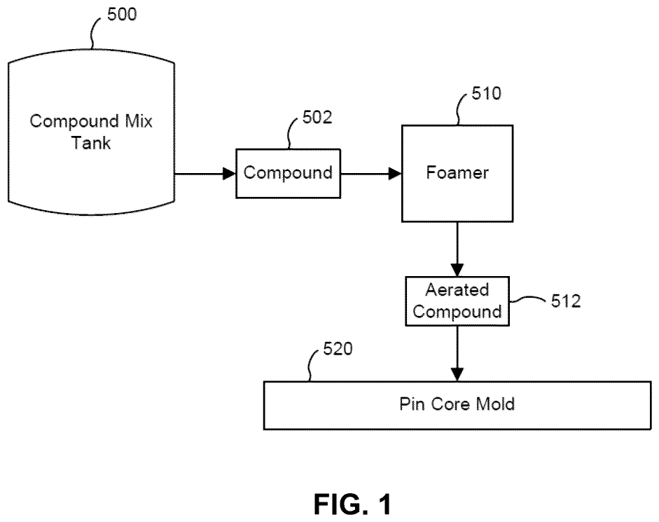

FIG. 1 illustrates an exemplary Talalay process, according to one or more embodiments disclosed herein. Blends of natural and synthetic latex rubber may be combined with soap, curing agents, and/or several other processing aid materials into a compound mix tank 500. The resulting compound 502 may be directed or sent through a foamer 510 incorporating air into the compound 502 to form a foamed or aerated compound 512. In some embodiments, where a pre-agglomeration latex rubber is utilized, it may be desirable to increase the amount of soap in the latex formulation, preferably by around 40% or more, and more preferably, by around 60% or more. This allows for better stabilization of the latex formulation to allow it to foam properly.

After the foamer aeration step, the foamed compound 512 may be distributed into an opened pin-core mold 520 in a precise or predetermined volume and pattern. The mold 520 may be designed to be closed and sealed with pressure provided by press hydraulics. After closing the mold 520, a vacuum may be applied to the interior, thereby causing the air matrix bubbles to ‘inflate’ and fill out the pattern and volume of the mold 520.

The mold 520 and compound 512 may then be subjected to a specific series of vacuum, freezing, gas injection, and heating. While being supported by the vacuum, the mold 520 and foam mass temperature may be reduced to about −20° F. (about −28° C.) and frozen in place. Because the resultant foam matrix may be open, carbon dioxide may be pushed through the structure, thereby forming carbonic acid that moves the pH from above 10 to 7. The reduction in alkalinity may trigger the foam to gel in place and hold its shape.

The temperature of the mold 520 may then be incrementally raised to the vulcanization temperature of about 230° F. (about 115° C.) for a measured or predetermined amount of time to vulcanize the rubber. The compound inside the mold may then be cooled again to a lower temperature (e.g., about 100° F.) to allow for the mold to be safely opened.

At this point, the foam form may be de-molded and sent to a washing step, wherein it may be washed with water. After washing, the foam form may be dried in the oven to complete a curing cycle of the compound. The finished latex foam compound may then be fabricated to size for the intended use. In some embodiments, the foamed compound 512 may be used in a bedding product, such as mattresses and mattress toppers, from twin XL up to California Kings, and pillows. Various means may then be employed to incorporate the foamed compound 512 into the bedding product. The resulting bedding product may have any desired thickness, as well as outer dimensions.

The foamed compound may also be formed into a bedding product using a continuous process (not shown). In the continuous process, the foamed compound may be cast onto a moving belt, e.g., from a casting wand. The moving belt may transport the foamed compound through a series of processes (e.g., by means of a roller). The first step may be a metering system which may use a doctor blade to establish the height or thickness of the casting. The foamed compound coming under the doctor blade may be subjected to an infrared (IR) light, passed through a steam box, and then finally through a drier. The compound may be gelled, vulcanized, and then dried. At the end of the continuous process the material may be trimmed, punched, and cut to length or wrapped onto rolls.

The inventors have discovered unexpectedly that the formulation and process produce a block of latex foam that has dual densities. For example, the formulation and/or methods disclosed herein may be utilized to fabricate or manufacture dual density blocks of latex foam having a first density and a second density, where the first density is firmer or greater than the second density. Accordingly, the dual density blocks of latex foam may have a first side having the first density (e.g., firm) and a second side having the second density (e.g., plush). This is an advantageous and very desirable feature as it may be used to produce dual density pillows, mattresses, and mattress toppers to provide more customizable customer experience without the need to adhere latex foam pieces of varying densities together. Another advantage of the novel process may be that it allows for use of the same latex formulation in a single mold process to create a block of latex foam that has sides with different densities. This may avoid the need for using different latex formulations in the same mold to create a block with dual densities or having to separately mold blocks of latex foam with different densities and then adhere the blocks together.

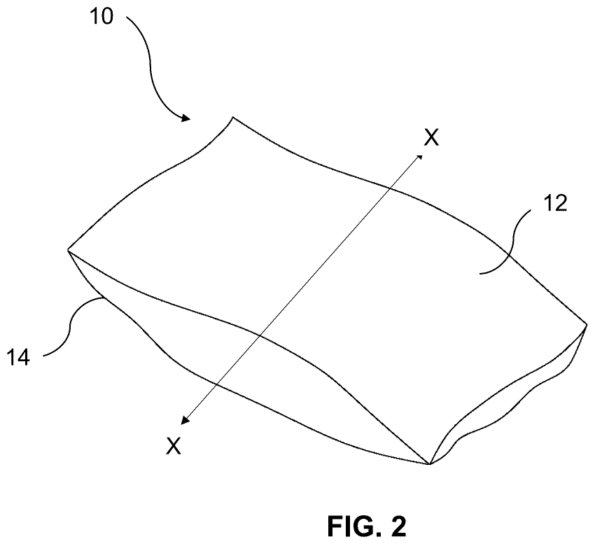

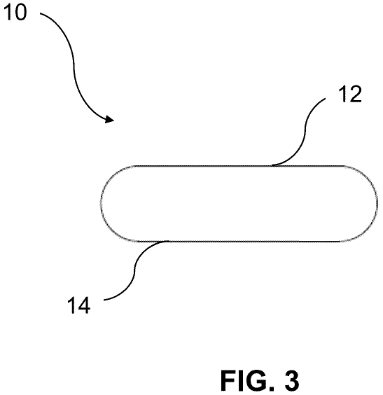

FIGS. 2 and 3 illustrate an exemplary solid block of latex foam in a shape of a pillow 10. The pillow 10 or the block of latex foam disclosed herein may be monolithic. Accordingly, the pillow 10 or the block of latex foam disclosed herein may be a single monolithic structure as opposed to two separate foam blocks coupled with one another via conventional means (e.g., adhesives). As illustrated in FIGS. 2 and 3, each block or pillow 10 may have a top side 12 and a bottom side 14. The top side 12 may have a first density and the bottom side 14 may have a second density. The first density may be the same or different than the second density. In an exemplary embodiment, the first density may be relatively greater than the second density. It should be appreciated that the term “density,” with reference to the foam block, is related to the firmness thereof. For example, increasing density of the top side 12 or bottom side 14 may correspondingly increase a firmness of the top side 12 or the bottom side 14, respectively.

In at least one embodiment, the top side 12 may have an Impression Load Deflection (ILD) value of about 2.8 to about 4.0. For example, the top side 12 may have an ILD value of about 2.8, about 3, about 3.2, about 3.4, or about 3.6 to about 3.8, or about 4.0. The bottom side 14 may have an ILD value of about 3.2 to about 5. For example, the bottom side 14 may have an ILD value of about 3.2, about 3.4, about 3.6, about 3.8, or about 4 to about 4.2, about 4.4, about 4.6, about 4.8, or about 5. It should be appreciated that the top side 12 and the bottom side 14 are merely spatial representations of “a first side” and “a second side” and is not intended to limit the actual side to either the bottom or top. In at least one embodiment, the bottom side 14 (e.g., the second side) may have a relatively greater ILD value than the top side 12 (e.g., the first side). For example, the ILD value of the bottom side 14 may be greater than the ILD value of the top side 12 by about 10%, about 12%, about 14%, about 16%, about 18%, about 20%, about 22%, about 24%, about 26%, about 28%, about 30%, or more.

During use, a consumer may choose either the top side 12 or the bottom side 14 of the pillow 10 to rest their head on during sleep or rest. If the top side 12 and the bottom side 14 have different densities/firmness—e.g., one side is firm and the other side is plush—a consumer may have a more customizable experience by simply flipping the pillow 10 over.

The following numbered paragraphs are directed to one or more exemplary variations of the subject matter of the application:

1. A method of manufacturing a latex foam product, the method comprising: preparing a latex composition comprising one or more rubber materials; disposing the latex composition into a mold; foaming the latex composition inside the mold; and curing the latex composition to produce a solid block of foam; wherein the solid block of foam has a top side with a first density and a bottom side with a second density, wherein the first density is different from the second density.

2. The method of paragraph 1, wherein the one or more rubber materials comprise one or more natural rubbers, one or more synthetic rubbers, or a mixture thereof.

3. The method of paragraph 1 or 2, wherein the one or more rubber materials comprise styrene-butadiene rubber (SBR).

4. The method of any one of the foregoing paragraphs, wherein the latex foam product is a mattress, a pillow, or a mattress topper.

5. The method of any one of the foregoing paragraphs, wherein preparing the latex composition comprises diluting the latex composition with water to decrease a viscosity thereof.

6. The method of any one of the foregoing paragraphs, wherein the one or more rubber materials comprise a rubber solids content of about 55% or less.

7. The method of any one of the foregoing paragraphs, wherein the one or more rubber materials comprise a rubber solids content of about 40% to about 45%.

8. The method of any one of the foregoing paragraphs, wherein the first density is relatively greater than the second density.

9. The method of any one of the foregoing paragraphs, further comprising: creating a vacuum in the mold; flash freezing the latex composition; directing carbon dioxide into the mold; and curing the latex composition inside the mold with heat.

10. A molded latex foam block, comprising: one or more rubber materials, wherein the molded latex foam block is prepared in a single mold operation; wherein the molded latex foam block has a top side and a bottom side, wherein the top side has a first density and the bottom side has a second density, and wherein the first density is about 10% to about 90% of the second density.

11. The molded latex foam block of paragraph 10, wherein the one or more rubber materials comprise: about 70% to about 80% styrene-butadiene rubber (SBR); and about 20% to about 30% natural latex.

12. The molded latex foam block of paragraph 10 or 11, wherein the one or more rubber materials comprise a rubber solids content of about 55% or less.

13. The molded latex foam block of any one of paragraphs 10 to 12, wherein the one or more rubber materials comprise a rubber solids content of about 41% to about 45%.

14. The molded latex foam block of any one of paragraphs 10 to 13, further comprising at least one additive, wherein the at least one additive comprises one or more of a dye, a gelling agent, an accelerator, a curing agent, a soap, or any combination thereof.

15. The molded latex foam block of any one of paragraphs 10 to 14, wherein the molded latex foam block is free or substantially free from thickeners and/or viscosity increasing agents.

16. The molded latex foam block of any one of paragraphs 10 to 15, wherein the top side has a density of about 2 kg/m³ to about 4 kg/m³ and the bottom side has a density of about 3 kg/m³ to about 5 kg/m³.

17. The molded latex foam block of any one of paragraphs 10 to 16, wherein the molded latex foam block is a monolithic foam block.

18. The molded latex foam block of any one of paragraphs 10 to 17, wherein the molded latex foam block comprises an Impression Load Deflection value of about 1 to about 80, or about 2 to about 50.

19. A method of manufacturing a latex foam product, the method comprising: preparing a latex composition comprising one or more rubber materials having a rubber solids content of about 55% or less; disposing the latex composition into a mold; foaming the latex composition inside the mold; and curing the latex composition to produce a solid block of foam.

20. The method of paragraph 19, wherein the latex composition has a viscosity of about 800 centipoise or more, and wherein the solid block of foam has a substantially consistent density.

### EXAMPLES

The examples and other implementations described herein are exemplary and not intended to be limiting in describing the full scope of compositions and methods described herein. Equivalent changes, modifications, and variations of specific implementations, materials, compositions, and methods may be made within the scope of the implementations or embodiments described herein, with substantially similar results.

### Example 1

Exemplary blocks of latex foam (1)-(12) were prepared according to the Talalay process described herein. The blocks (1)-(12) were prepared from a liquid latex formulation with latex base components having a rubber solids content of about 41%. The molded blocks (1)-(12) were about Queen-sized pillows similar to the pillow 10 shaped blocks of FIGS. 2 and 3. The blocks (1)-(12) were subjected to density testing and Impression Load Deflection (ILD) method testing. The ILD method is a measure of the softness or firmness of a foam bedding product, such as a mattress or a pillow. ILD is measured by pressing an 8-inch round disk into a Queen-sized pillow until it presses 25% or one inch into the bedding product surface, such as, e.g., surface 12 and surface 14 in FIG. 2. The amount of weight or pressure required to compress the foam product to that extend is the ILD. Separate ILD measurements were performed for the top side 12 and the bottom side 14 of each of the blocks (1)-(12). The ILD measurements are summarized in Table 1 below. It should be appreciated that the density was measured as the weight of a Queen-sized pillow divided by a volume of the Queen-sized pillow. Average densities of each pillow block (1)-(12) were calculated and summarized in Table 1.

TABLE 1

| | | | | | | Average |
|---|---|---|---|---|---|---|
| | Weight | Top | Bottom | ILD | % | Density |
| No. | (lbs.) | ILD | ILD | Difference | Change | (lbs./ft³) |
| 1 | 2.475 | 3.580 | 4.480 | 0.900 | 25.14 | 1.58 |
| 2 | 2.435 | 3.560 | 4.130 | 0.570 | 16.01 | 1.53 |
| 3 | 2.510 | 3.480 | 3.940 | 0.460 | 13.22 | 1.56 |
| 4 | 2.570 | 3.800 | 4.840 | 1.040 | 27.37 | 1.55 |
| 5 | 2.405 | 3.410 | 3.760 | 0.350 | 10.26 | 1.49 |
| 6 | 2.375 | 3.340 | 3.730 | 0.390 | 11.68 | 1.50 |
| 7 | 2.365 | 3.630 | 4.140 | 0.510 | 14.05 | 1.56 |
| 8 | 2.345 | 2.940 | 3.310 | 0.370 | 12.59 | 1.38 |
| 9 | 2.270 | 3.180 | 3.600 | 0.420 | 13.21 | 1.37 |
| 10 | 2.480 | 3.810 | 4.400 | 0.590 | 15.49 | 1.58 |
| 11 | 2.080 | 2.950 | 3.370 | 0.420 | 14.24 | 1.36 |
| 12 | 2.525 | 3.960 | 4.760 | 0.800 | 20.20 | 1.58 |

As seen from Table 1, each of the pillows/blocks (1)-(12) had dual densities, with the difference between respective densities of the top and bottom sides of each blocks (1)-(12) being between about 10% to about 30%. This result was both surprising and unexpected, and has not been achieved in conventional latex foam products or latex foam blocks thereof. As described above, it is typically necessary to mechanically adhere blocks of latex foam having different densities/firmness together to obtain a single, monolithic composite block with dual densities. The method of the present disclosure is superior and advantageous in that it does not require the additional step of adhering different foams, which saves on manufacturing cost and time, as well as eliminates issues with integrity of such composite foam over time/use.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present disclosure and the appended claims in any way.

While the devices, systems, and methods have been described in detail herein in accordance with certain preferred implementations thereof, many modifications and changes therein may be affected by those skilled in the art. Accordingly, the foregoing description should not be construed to be limited thereby but should be construed to include such aforementioned obvious variations and be limited only by the spirit and scope of the following claims.

What is claimed is:

1. A method of manufacturing a latex foam product, the method comprising:
preparing a latex composition comprising one or more rubber materials;
disposing the latex composition into a mold;
foaming the latex composition inside the mold; and
curing the latex composition to produce a solid block of foam;
wherein the solid block of foam has a top side with a first density and a bottom side with a second density, wherein the first density is different from the second density.

2. The method of claim 1, wherein the one or more rubber materials comprise one or more natural rubbers, one or more synthetic rubbers, or a mixture thereof.

3. The method of claim 1, wherein the one or more rubber materials comprise styrene-butadiene rubber (SBR).

4. The method of claim 1, wherein the latex foam product is a mattress, a pillow, or a mattress topper.

5. The method of claim 1, wherein preparing the latex composition comprises diluting the latex composition with water to decrease a viscosity thereof.

6. The method of claim 1, wherein the one or more rubber materials comprise a rubber solids content of about 55% or less.

7. The method of claim 6, wherein the one or more rubber materials comprise a rubber solids content of about 40% to about 45%.

8. The method of claim 1, wherein the first density is relatively greater than the second density.

9. The method of claim 1, further comprising:
creating a vacuum in the mold;
flash freezing the latex composition;
directing carbon dioxide into the mold; and
curing the latex composition inside the mold with heat.

10. A molded latex foam block, comprising:
one or more rubber materials,
wherein the molded latex foam block is prepared in a single mold operation;
wherein the molded latex foam block has a top side and a bottom side,
wherein the top side has a first density and the bottom side has a second density, and
wherein the first density is about 10% to about 90% of the second density.

11. The molded latex foam block of claim 10, wherein the one or more rubber materials comprise:
about 70% to about 80% styrene-butadiene rubber (SBR); and
about 20% to about 30% natural latex.

12. The molded latex foam block of claim 10, wherein the one or more rubber materials comprise a rubber solids content of about 55% or less.

13. The molded latex foam block of claim 12, wherein the one or more rubber materials comprise a rubber solids content of about 41% to about 45%.

14. The molded latex foam block of claim 10, further comprising at least one additive, wherein the at least one additive comprises one or more of a dye, a gelling agent, an accelerator, a curing agent, a soap, or any combination thereof.

15. The molded latex foam block of claim 10, wherein the molded latex foam block is free or substantially free from thickeners and/or viscosity increasing agents.

16. The molded latex foam block of claim 10, wherein the top side has a density of about 2 kg/m³ to about 4 kg/m³ and the bottom side has a density of about 3 kg/m³ to about 5 kg/m³.

17. The molded latex foam block of claim 10, wherein the molded latex foam block is a monolithic foam block.

18. The molded latex foam block of claim 10, wherein the molded latex foam block comprises an Impression Load Deflection value of about 1 to about 80, or about 2 to about 50.

19. A method of manufacturing a latex foam product, the method comprising:
preparing a latex composition comprising one or more rubber materials having a rubber solids content of about 55% or less;
disposing the latex composition into a mold;
foaming the latex composition inside the mold; and
curing the latex composition to produce a solid block of foam.

20. The method of claim 19, wherein the latex composition has a viscosity of about 800 centipoise or more, and wherein the solid block of foam has a substantially consistent density.
